(19) United States
(12) Patent Application Publication
(10) Pub. No.: US 2011/0075988 A1
(43) Pub. Date: Mar. 31, 2011

(54) Multi-Media System

(75) Inventor: Chi-Chen Cheng, Taipei City (TW)

(73) Assignee: iPeer Multimedia International Ltd., Taipei City (TW)

(21) Appl. No.: 12/242,046

(22) Filed: Sep. 30, 2008

(30) Foreign Application Priority Data
Apr. 24, 2008 (TW) 097207031

(51) Int. Cl. H04N 5/91

(52) U.S. Cl. 386/240; 386/E05.003

(57) ABSTRACT

A multi-media system includes an audio and video data provider, a writing device and a player. The audio and video data provider provides audio and video data. The player provides personal data. The writing device receives the audio and video data and the personal data and adds the personal data to the audio and video data before transferring the audio and video data and the personal data to the player. The writing device includes a display module for showing a first sub-screen and a second sub-screen including an account zone and a time-and-address zone.

### FIELD OF INVENTION

The present invention relates to a multi-media system and, more particularly, to a multi-media system for adding personal data to audio and video (“AV”) data so that the personal data can be shown as well as the AV data to avoid the illegal copying of the AV data.

### BACKGROUND OF INVENTION

Computers are often connected to websites through the Internet so that multi-media data can be downloaded to the computers from the websites through the Internet. The multi-media data can be stored in and played by the computers. Alternatively, multi-media players can be connected to the computers so that the multi-media data can be stored in and played by the multi-media players.

Whatever formats they are in, the multi-media data only include AV data. Any user can play, store, record and/or transfer the multi-media data deliberately and often illegally.

Hence, websites encrypt multi-media data based on voiceprints or directly encrypt the multi-media data before they provide the multi-media data to users, thus preventing the users from illegally copying the multi-medial data. The encryption is however not strict and might be cracked. In that case, the multi-medial data could be illegally copied.

The present invention is therefore intended to obviate or at least alleviate the problems encountered in prior art.

### SUMMARY OF INVENTION

It is the primary objective of the present invention to provide a multi-media system for avoiding illegal copying of audio and video data.

To achieve the foregoing objective, the multi-media system includes an audio and video data provider, a writing device and a player. The audio and video data provider provides audio and video data. The player provides personal data. The writing device receives the audio and video data and the personal data and adds the personal data to the audio and video data before transferring the audio and video data and the personal data to the player. The writing device includes a display module for showing a first sub-screen and a second sub-screen including an account zone and a time-and-address zone.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a multi-media system according to the preferred embodiment of the present invention.

FIG. 2 is a block diagram of the multi-media system shown in FIG. 1.

FIG. 3 is a perspective view for showing the operation of the multi-media system shown in FIG. 1.

### DETAILED DESCRIPTION OF PREFERRED EMBODIMENT

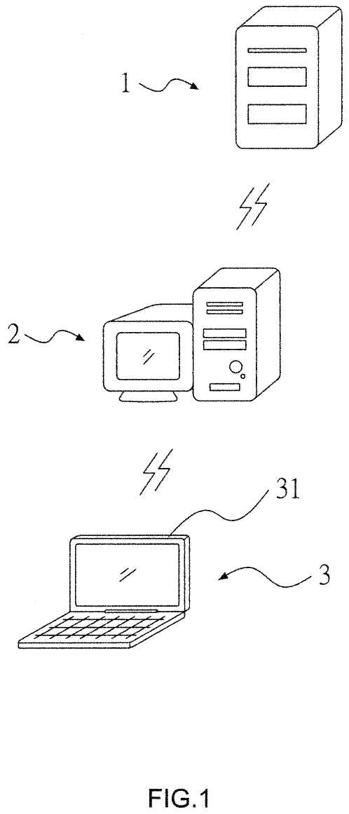

Referring to FIG. 1, a multi-media system includes an AV data provider 1, a writing device 2 and a player 3 according to the preferred embodiment of the present invention.

The multi-media data provider 1 provides AV data 11. The AV data 11 may be provided in MPEG files, AVI files, compressed files or motion-picture files. The AV data provider 1 may be a web server, a desktop computer or a laptop computer.

The writing device 2 is connected to the AV data provider 1. The writing device 2 receives the AV data from the AV data provider 1 and adds personal data to the AV data. The writing device 2 may be a personal computer or a combination of a control unit with a storage unit.

The player 3 may be a desktop computer, a laptop computer or a combination of a cellular phone with a camera. The player 3 is connected to the writing device 2 so that the player 3 provides the personal data to the writing device 2 before the writing device 2 transfers the AV data 11 to the player 3.

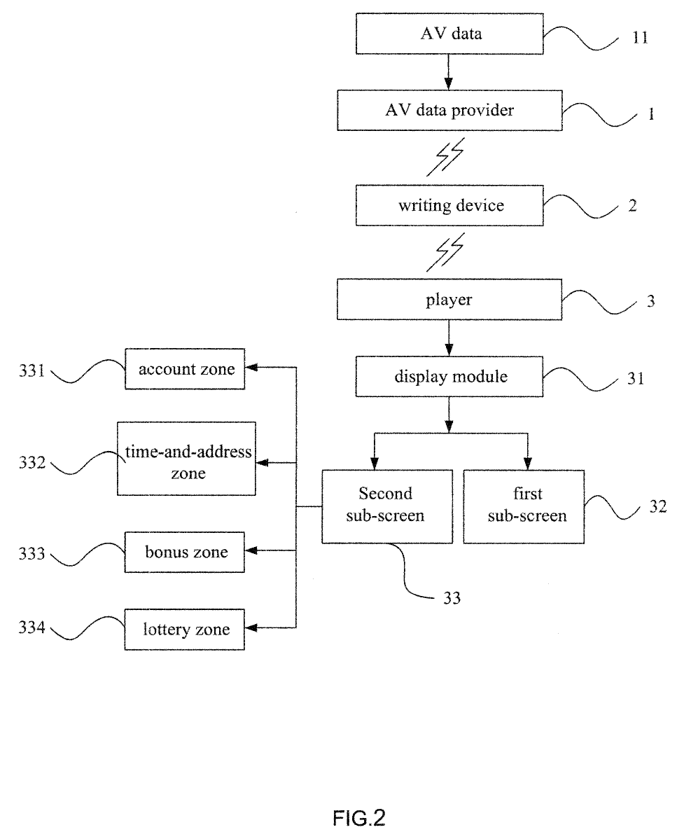

Referring to FIG. 2, the player 3 includes a display module 31. The screen of the display module 31 is divided into a first sub-screen 32 and a second sub-screen 33. The secondary sub-screen 33 includes an account zone 331, a time-and-address zone 332, a bonus zone 333 and a lottery zone 334.

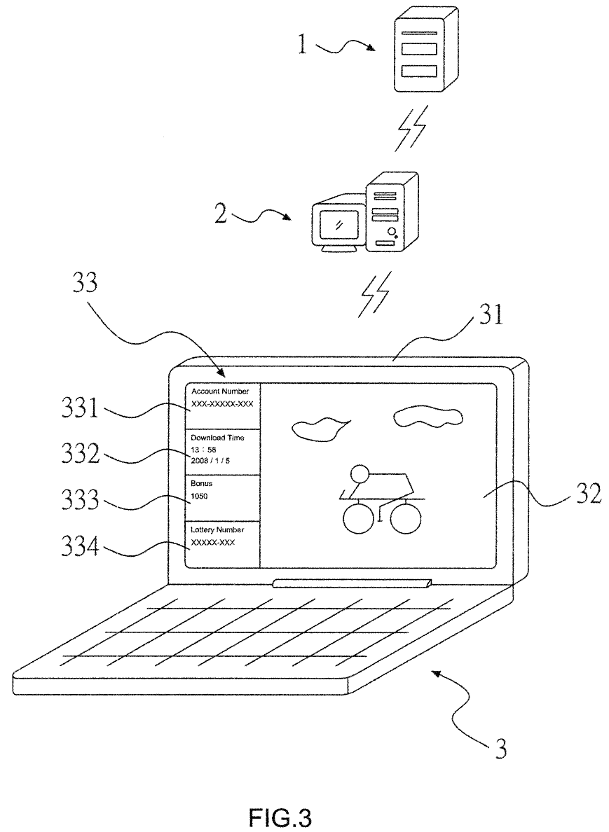

Referring to FIG. 3, the AV data provider 1, the writing device 2 and the player 3 are in communication of data with one another wirelessly or through cables. The wireless communication of data between these elements may proceed according to the WiFi protocol, the Bluetooth protocol or the RF protocol.

Wishing to download the AV data 11 from the AV data provider 1, a user connects the player 3 to the AV data provider 1 via the writing device 2. The user provides the personal data to the writing device 2 before selecting the AV data 11 from the AV data provider 1. The AV data provider 1 provides the AV data 11 to the writing device 2. The writing device 2 adds the personal data to the AV data 11. The personal data include data related to the user and data about the downloading of the AV data 11. Then, the writing device 2 provides the player 3 with the AV data 11 added with the personal data.

Based on the AV data 11, the display module 31 shows the first sub-screen 32 and the second sub-screen 33. The second sub-screen 33 is normally shown on the display module 31. Each of the zones 331, 332, 333 and 334 is a rectangular frame, a square frame or any other polygonal frame or in motion pictures. The account zone 331 shows the account and identification of the user. The time-and-address zone 332 shows the time and IP address about the downloading of the AV data 11 and keeps a record on how many times the AV data 11 have been downloaded to the IP address. The bonus zone 333 shows accumulated bonus. The lottery zone 334 shows a lottery number generated by the AV data provider 1. Thus, the personal data are always shown as well as the AV data 11. The AV data 11 cannot be spread without the AV data 11. This prevents illegal copying of the AV data 11.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multi-media system comprising:
an audio and video data provider for providing audio and video data;
a player for providing personal data; and
a writing device for receiving the audio and video data and the personal data and adding the personal data to the audio and video data before transferring the audio and video data and the personal data to the player, wherein the writing device comprises a display module for showing a first sub-screen and a second sub-screen including an account zone and a time-and-address zone.

2. The multi-medial system according to claim 1, wherein the audio and video data provider is selected from a group consisting of a web server, a desktop computer and a laptop computer.

3. The multi-medial system according to claim 1, wherein the audio and video data are provided in a format selected from a group consisting of the MPEG format, the AVI format, a compressed format and a motion-picture format.

4. The multi-medial system according to claim 1, wherein the communication of data between the audio and video data provider, the player and the writing device proceeds according to a protocol selected from a group consisting of the WiFi protocol, the Bluetooth protocol and the RF protocol.

5. The multi-medial system according to claim 1, wherein the communication of data between the audio and video data provider, the player and the writing device is done through cables.

6. The multi-medial system according to claim 1, wherein the writing device is a desktop computer.

7. The multi-medial system according to claim 1, wherein the writing device is a combination of a control unit with a storage unit.

8. The multi-medial system according to claim 1, wherein the player is selected from a group consisting of a desktop computer, a laptop computer and a combination of a cellular phone with a camera.

9. The multi-medial system according to claim 1, wherein the second sub-screen comprises rectangular frames.

10. The multi-medial system according to claim 1, wherein the second sub-screen comprises square frames.

11. The multi-medial system according to claim 1, wherein the second sub-screen comprises polygonal frames.

12. The multi-medial system according to claim 1, wherein the second sub-screen comprises motion pictures.

13. The multi-medial system according to claim 1, wherein the second sub-screen comprises a bonus zone and a lottery zone.
